(19) United States
(12) Patent Application Publication
(10) Pub. No.: US 2008/0173021 A1
(43) Pub. Date: Jul. 24, 2008

(54) Method for improved efficiency for IGCC

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 11/787,578

(22) Filed: Apr. 17, 2007

Related U.S. Application Data
(60) Provisional application No. 60/792,737, filed on Apr. 17, 2006.

(51) Int. Cl. F02C 7/00

(52) U.S. Cl. 60/780; 60/783

(57) ABSTRACT

The invention provides a method for operating an oxygen blown integrated coal gasification combined cycle gas turbine (IGCC) system having a gasifier and an air separation unit. A supply of low pressure nitrogen is passed to a gas turbine compressor along with sufficient air to provide sufficient compressed air to the gas turbine combustor for gasified fuel combustion. Subsequently, at least a sufficient portion of the compressor discharge flow is passed to a combustor for combustion of the gasified fuel flow to the combustor. The gasified fuel is combusted to produce hot combustion gases and then the combustion gases are passed to a turbine.

### CROSS-REFERENCE

This application claims the benefit of U.S. Provisional Application No. 60/792,737 filed Apr. 17, 2006.

### FIELD OF THE INVENTION

The present invention is a method for improving the thermal efficiency of power systems wherein a coal gasification plant supplies syngas or hydrogen to one or more gas turbines for power production. In particular, the present invention relates to a method of improving the thermal efficiency of integrated coal gasification combined cycle gas turbine (IGCC) systems. More particularly, the present invention comprises a method for minimizing the need to extract compressor discharge air to limit mass flow through the power turbine, as is typically required to maintain turbine rotor stress levels within acceptable limits. IGCC systems of the present invention allow increased turbine inlet temperature, further improving system efficiency.

### BACKGROUND OF THE INVENTION

With energy usage directly related to economic growth, there has been a steady increase in the need for increased energy supplies. In the U.S., coal is abundant and low in cost. Unfortunately, conventional coal-fired steam plants, which are a major source of electrical power, are inefficient and pollute the air. Thus, there is a pressing need for cleaner, more efficient coal-fired power plants. Accordingly, IGCC systems have been developed which can achieve significantly improved efficiencies in comparison to conventional steam plants. In such a system, syngas (a mixture of hydrogen and carbon monoxide) is produced by partial oxidation of coal or other carbonaceous fuel. This allows cleanup of sulfur and other impurities before combustion. Moreover, if carbon sequestration is desired, the carbon monoxide can be reacted with steam using the water gas shift reaction to form carbon dioxide and hydrogen. Carbon dioxide may then be recovered using conventional technologies known in the art. This allows pre-combustion recovery of carbon dioxide for sequestration.

Regardless of whether carbon dioxide is recovered or whether air or oxygen are used for syngas production, the hydrogen content of the gas is typically too high to allow use of conventional dry low NOx premixed combustion for NOx control. Therefore, diffusion flame combustion is used with diluent added to the syngas from oxygen blown gasifiers to minimize NOx. Even so, exhaust gas cleanup may still be required. Thus, such systems may be cleaner and more efficient; however, these systems typically cannot achieve present standards for NOx emissions without removal of NOx from the exhaust gas and the consequent efficiency loss. Improved combustion systems such as that taught in U.S. Pat. No. 6,358,040 are needed.

There are further efficiency loss issues. If nitrogen is used to dilute the fuel gas, there is an energy penalty for nitrogen compression to the pressure needed for mixing with the fuel gas. In addition, use of syngas in a gas turbine designed for natural gas increases turbine mass flow even without syngas dilution. Typically, to avoid excessive loads on the turbine rotor requires operation at a reduced turbine temperature and/or bleed of compressed air from the turbine compressor.

Although IGCC systems are more efficient than steam plants, power requirements for gasification and gas cleanup decrease system efficiency. The gasifiers of such systems may be either air or oxygen blown. In either case the required air supply must be compressed to permit the gasifier to operate at an optimum pressure level. Although some of the air for the gasifier may be supplied by the gas turbine compressor, auxiliary compressors are typically employed to supply most of the air needed for coal gasification. Energy use for air compression is minimized by use of inter-cooled multistage compressors rather than adiabatic compressors, particularly with oxygen blown gasifiers. Thus use of high temperature turbine compressor bleed air is disadvantageous.

The by-product nitrogen is available for mixing with the fuel gas to reduce NOx production in diffusion flame combustion of the syngas, but it must be compressed. The nitrogen must be at sufficiently high pressure for admixture with the syngas before combustion. An advantage of oxygen blown gasifiers is a greatly reduced volume of nitrogen in the syngas which allows more economical pre-combustion clean up and recovery of carbon for sequestration as carbon dioxide. This is particularly attractive if sequestration can be combined with carbon dioxide enhanced oil recovery.

### SUMMARY OF THE INVENTION

The present invention is a method of significantly reducing auxiliary power requirement in oxygen blown IGCC systems and in maximizing the gas turbine efficiency. It has now been found that the need to admix nitrogen with syngas for NOx reduction, and thus the need for compressed nitrogen, can be avoided by substituting an inert gas for a portion of the turbine inlet air, e.g. with atmospheric pressure nitrogen from the air separation plant. High purity nitrogen is not required. There is no increase in turbine mass flow as would be the case with addition of nitrogen to the fuel gas.

It has been found that if the oxygen content of the compressor discharge air is limited, preferably to an amount needed to supply the combustion zone with sufficient oxygen for combustion of the fuel fed thereto, NOx production is reduced and the mass flow through the turbine is not increased as it would be with nitrogen or steam dilution of the fuel. This means there is no resultant need to bleed off compressor discharge air or to lower turbine inlet temperature to compensate for the added diluent mass flow as is the practice in state of the art IGCC systems. With high hydrogen content feeds such as produced with carbon dioxide removal, mass flow may actually be somewhat lower than with natural gas fuels.

Inasmuch as the nitrogen can be available at a temperature much lower than ambient air temperature, compressor inlet temperature can be maintained at a value for maximum efficiency and power even at high ambient air temperatures. This improves system efficiency. Inasmuch as no nitrogen or steam diluent need be added to the fuel, no reduction in turbine inlet temperature is needed to compensate for the resulting increased mass flow through the gas turbine, and there is no need to bleed off compressor discharge air to reduce turbine mass flow. Conventional diffusion flame combustors may be used but use of a catalytic combustor allows lower NOx. A preferred system such as a rich catalytic reactor to produce a partially reacted fuel prior to downstream combustion such as taught in U.S. Pat. No. 6,358,040 allows very low NOx and more stable combustion.

### BRIEF DESCRIPTION OF THE DRAWINGS

FIG. 1 represents a simplified schematic diagram of oxygen blown IGGC system.

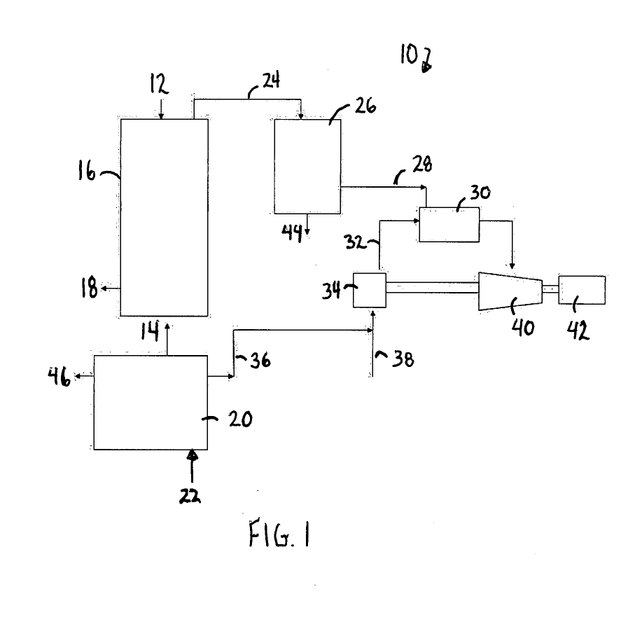

### DETAILED DESCRIPTION OF THE INVENTION

As shown, IGCC system 10 comprises passing coal 2 and oxygen 4 into gasifier 16. Numerous gasifier designs have been developed including entrained flow, fluidized bed systems and countercurrent flow designs. Ash 18 is removed for disposal. Oxygen is supplied by an air separation plant 20 which may be a membrane separator or more typically an air liquefaction plant. Feed air 22, typically compressed using intercooler compressors, and raw syngas 24 are passed into gas cleaning unit 26 for removal of mercury, sulfur and other contaminates. If carbon is to be sequestered, a water gas shift reactor is included along with a carbon dioxide recovery system. Cleaned product gas 28 is passed into gas turbine combustor 30 for combustion with compressed air 32 from gas turbine compressor 34. Nitrogen 36 is mixed with ambient air 38 for supply to compressor 34 with reduced oxygen content feed. The system depicted includes turbine 40 and generator 42, waste 44 gas cleaning unit 26, and exhaust air 46 from air separation plant 20 for illustrative purposes.

While the present invention has been described in considerable detail with reference to a preferred method for efficiently running an IGCC system, other methods exhibiting the characteristics taught herein are contemplated. Therefore, the spirit and scope of the invention should not be limited to the description of the preferred embodiment described herein.

1. The method of operating an oxygen blown IGCC system having a fuel gasifier and an air separation unit comprising:
a) obtaining a supply of low pressure nitrogen;
b) passing the nitrogen to a gas turbine compressor along with sufficient air to provide sufficient compressed air to the gas turbine combustor for gasified fuel combustion;
c) passing at least a sufficient portion of the compressor discharge flow to a combustor for combustion of the gasified fuel flow to the combustor;
d) combusting the gasified fuel to produce hot combustion gases; and
e) passing the combustion gases to a turbine.

2. The method of claim 1 wherein air required by the air separation unit is supplied by a multistage inter-cooled compressor.

3. The method of claim 1 wherein the turbine is operated at a higher turbine inlet temperature than would be used with nitrogen diluted syngas fuel.

4. The method of claim 1 wherein the turbine is operated at a higher turbine inlet temperature than would be used with steam diluted syngas fuel.

5. The method of claim 1 wherein the combustor comprises a rich catalytic reactor for reaction of the fuel prior to downstream combustion.
